(19) United States
(12) Patent Application Publication
(10) Pub. No.: US 2024/0376618 A1
(43) Pub. Date: Nov. 14, 2024

(54) INFORMATION PROCESSING APPARATUS, HYDROGEN PRODUCTION SYSTEM, POWER SUPPLY SYSTEM, OPERATION PLAN CREATION METHOD, AND COMPUTER PROGRAM

(71) Applicants: ENEOS Corporation, Chiyoda-ku, Tokyo (JP); NATIONAL INSTITUTE OF ADVANCED INDUSTRIAL SCIENCE AND TECHNOLOGY, Chiyoda-ku, Tokyo (JP)

(72) Inventors: Kosuke HARADA, Chiyoda-ku, Tokyo (JP); Hirofumi TAKAMI, Chiyoda-ku, Tokyo (JP); Ichiro OKUMO, Chiyoda-ku, Tokyo (JP); Kazuki UEHARA, Chiyoda-ku, Tokyo (JP); Hirokazu KOJIMA, Koriyama-shi, Fukushima (JP); Hiroshi KIKUSATO, Koriyama-shi, Fukushima (JP); Takashi OOZEKI, Koriyama-shi, Fukushima (JP); Hirohide FURUTANI, Koriyama-shi, Fukushima (JP)

(73) Assignees: ENEOS Corporation, Chiyoda-ku, Tokyo (JP); NATIONAL INSTITUTE OF ADVANCED INDUSTRIAL SCIENCE AND TECHNOLOGY, Chiyoda-ku, Tokyo (JP)

(21) Appl. No.: 18/692,687

(22) PCT Filed: Aug. 15, 2022
(86) PCT No.: PCT/JP2022/030886

§ 371 Date: Mar. 15, 2024

(30) Foreign Application Priority Data
Sep. 16, 2021 (JP) 2021-151053

(51) Int. Cl. C25B 15/02; C25B 1/04; H01M 8/0656; H02J 3/38

(52) U.S. Cl. CPC C25B 15/02; C25B 1/04; H01M 8/0656; H02J 3/381; H02J 2203/10; H02J 2300/30

(57) ABSTRACT

A hydrogen production system includes a hydrogen production facility and a management server. The management server includes an operation plan creation unit and an operation plan output unit. The operation plan creation unit creates an operation plan for the hydrogen production facility. The operation plan output unit outputs data including the operation plan created by the operation plan creation unit. The operation plan creation unit creates an operation plan for the hydrogen production facility including a demand response possible amount for each unit time based on a demand response consideration for each unit time determined in advance.

### TECHNICAL FIELD

The present disclosure relates to a data processing technology, and specifically relates to an information processing apparatus, a hydrogen production system, a power supply system, an operation plan creation method, and a computer program.

### BACKGROUND ART

Hydrogen production facilities that produce hydrogen by electrolyzing water and hydrogen production facilities that produce hydrogen by reforming city gas are known (see, for example, Patent Literature 1).

### PRIOR ART LITERATURE

### Patent Literature

Patent Literature 1: JP2021-046600 A

### SUMMARY OF INVENTION

### Technical Problem

Conventionally, an operation plan for a hydrogen production facility has been created according to hydrogen demand for each time and cost of energy (for example, electric power) to be used. Since the hydrogen production facility can control power demand, the hydrogen production facility can provide power supply and demand adjustment power.

In general, the available capacity of the controllable amount of the hydrogen production facility is calculated based on the operation plan created without considering provision of the power supply and demand adjustment power, and a demand response possible amount is calculated. However, this method, in which the remaining amount of stored hydrogen and the consideration for the demand response are not considered, cannot respond to a demand response command in some cases, and the earning obtained by the demand response may be reduced.

The present disclosure has been made in view of such problems, and one of the objects of the present disclosure is to provide a technology for supporting creation of an efficient operation plan for a hydrogen production facility.

### Solution to Problem

To solve the above problem, an information processing apparatus according to an aspect of the present disclosure includes a processor. The processor executes a first step of creating an operation plan for a hydrogen production facility including a demand response possible amount for each unit time based on a demand response consideration for the each unit time, and a second step of outputting data including the operation plan created in the first step.

Another aspect of the present disclosure is a hydrogen production system. The hydrogen production system includes a hydrogen production facility and an information processing apparatus. The information processing apparatus executes a first step of creating an operation plan for a hydrogen production facility including a demand response possible amount for each unit time based on a demand response consideration for the each unit time, and a second step of outputting data including the operation plan created in the first step.

Still another aspect of the present invention is a power supply system. The power supply system is a power supply system that supplies power to a power grid using power obtained from a renewable energy power generator that generates power using renewable energy, the power supply system including a power conditioner device that adjusts power generated by the renewable energy power generator, a storage battery capable of storing and discharging at least a part of surplus power that is not supplied to the power grid among power adjusted by the power conditioner device, a hydrogen production facility that produces hydrogen by using at least a part of the surplus power that is not supplied to the power grid among the power adjusted by the power conditioner device, a hydrogen storage facility capable of storing and releasing hydrogen produced by the hydrogen production facility, a fuel cell that generates power using hydrogen released from the hydrogen storage facility, and control means that controls at least an operation of the hydrogen production facility. The control means creates an operation plan for the hydrogen production facility including the demand response possible amount for each unit time based on the demand response consideration for the each unit time, and controls the hydrogen production facility based on the operation plan.

Yet still another aspect of the present disclosure is an operation plan creation method. In this method, a computer executes a first step of creating an operation plan for a hydrogen production facility including a demand response possible amount for each unit time based on a demand response consideration for the each unit time, and a second step of outputting data including the operation plan created in the first step.

Yet still another aspect of the present disclosure is a computer program. This computer program causes a computer to execute a first step of creating an operation plan for a hydrogen production facility including a demand response possible amount for each unit time based on a demand response consideration for the each unit time, and a second step of outputting data including the operation plan created in the first step.

Any combinations of the above-described components and expressions of the present disclosure converted between a recording medium or the like recording a computer program are also effective as aspects of the present disclosure.

### Advantageous Effects of Invention

The technology of the present disclosure can support creation of an efficient operation plan for a hydrogen production facility.

### BRIEF DESCRIPTION OF DRAWINGS

FIG. 1 is a diagram illustrating a configuration of a hydrogen production system of First Example.

FIG. 2 is a diagram illustrating a plurality of constants used in creation of an operation plan.

FIG. 3 is a diagram illustrating a plurality of variables used in creation of an operation plan.

FIG. 4 is a diagram illustrating the results of control simulation of First Example and Comparative Example.

FIG. 5 is a diagram illustrating the results of control simulation of First Example.

FIG. 6 is a diagram illustrating the results of control simulation of Comparative Example.

FIG. 7 is a diagram illustrating a configuration of a power supply system of Second Example.

### DESCRIPTION OF EMBODIMENTS

A subject of an apparatus or method in the present disclosure includes a computer. The functions of the subject of the apparatus or method in the present disclosure is implemented by this computer executing a computer program. The computer includes a processor that operates according to a computer program as a main hardware configuration. The type of the processor is not limited as long as the function can be implemented by executing the computer program. The processor includes one or a plurality of electronic circuits including a semiconductor integrated circuit (IC, LSI, or the like). The computer program is recorded in a non-transitory recording medium such as a computer-readable ROM, an optical disk, or a hard disk drive. The computer program may be stored in advance in a recording medium, or may be supplied to the recording medium via a wide-area communication network including the Internet or the like.

Hereinafter, the technology of the present disclosure will be described with reference to the drawings based on preferred Examples. The Examples are not intended to limit the invention, but are merely examples, and all the features described in Examples and combinations thereof are not necessarily essential to the invention. The same or equivalent components, members, and processing illustrated in the respective drawings are denoted by the same reference numerals, and redundant description will be omitted as appropriate. The scale and shape of each part illustrated in each drawing are set for convenience in order to facilitate the description, and are not limitedly interpreted unless otherwise specified. The terms “first”, “second”, and the like used in the present specification or claims do not represent any order or importance unless otherwise specified, and are intended to distinguish one configuration from another configuration.

### First Example

First, an outline of First Example will be described. The “demand response” (hereinafter, also referred to as “DR”) in First Example is a mechanism for adjusting a supply and demand balance of power by adjusting a power demand amount in accordance with a power supply amount. The DR includes an up DR and a down DR as patterns of demand control. The up DR is a control for increasing the power demand amount, and is performed, for example, when the output of a renewable energy becomes excessive. In other words, as one example, the up DR adjusts the supply and demand balance of power by increasing the power consumption. The down DR is a control for reducing the power demand amount, and is performed, for example, when the power consumption reaches a peak. In other words, as one example, the down DR adjusts the supply and demand balance of power by lowering the power consumption. Electric power consumers (companies and the like) can obtain consideration (which can also be said as earning or reward) for DR by controlling electric power consumption (in other words, power purchase amount) in accordance with a DR command.

Conventionally, an operation plan for a hydrogen production facility has been created according to hydrogen demand for each time and cost of energy (for example, electric power) as a raw material. Since the hydrogen production facility can control power demand, the hydrogen production facility can provide power supply and demand adjustment power. For example, the power supply and demand adjustment power is provided by transmitting the DR possible amount for each time to a resource aggregation system in advance, and controlling (for example, increasing or decreasing the electrolytic power amount) the operation of the hydrogen production facility according to the DR command generated within the range of the transmitted DR possible amount.

In general, the available capacity of the controllable amount of the hydrogen production facility is calculated based on the operation plan created without considering provision of the power supply and demand adjustment power, and the available capacity is used as the DR possible amount. However, this method does not take into account the stored hydrogen tank remaining amount (hereinafter, it is also referred to as a “hydrogen remaining amount”) and the DR consideration, and thus cannot respond to the DR command in some cases, and the earning obtained by responding to the DR is reduced in some cases.

Thus, in First Example, processing using a mathematical programming is executed on an objective function to derive the demand response possible amount for each unit time. In other words, based on the DR consideration for each unit time, an operation plan for the hydrogen production facility including the DR possible amount for each unit time is created. This realizes maximization of overall revenue. In First Example, an operation plan for a hydrogen production facility is created using a mathematical programming in consideration of the value of performing DR. The mathematical programming is a method of obtaining an explanatory variable that minimizes or maximizes (collectively referred to as “optimize”) an objective function while satisfying a predetermined constraint condition.

Specifically, in the hydrogen production system of First Example, a term representing the DR consideration is included in the objective function of a linear programming problem for creating the operation plan for the hydrogen production facility. In addition, as the constraint condition, a constraint for not deviating from the controllable range of the hydrogen production facility with any DR command is provided. This realizes an operation plan for the hydrogen production facility in which the earning from DR is quantitatively taken into consideration. It can be said that the operation plan for the hydrogen production facility is a plan in which the time-series electrolytic power, hydrogen production amount, operation amount, or the like of the hydrogen production facility is determined. For example, the operation plan for the hydrogen production facility may include a data group indicating electrolytic power, a hydrogen production amount, an operation amount, or the like for each unit time in a predetermined planning target period.

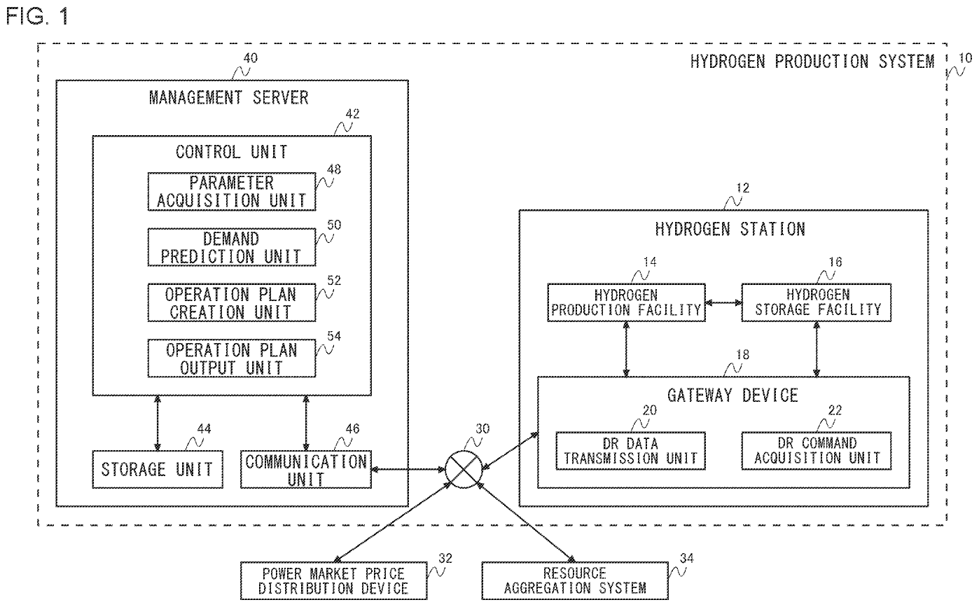

First Example will be described in detail. FIG. 1 illustrates a configuration of a hydrogen production system 10 of First Example. The hydrogen production system 10 includes a hydrogen station 12 and a management server 40. The hydrogen station 12 is a service station that produces, stores, and supplies hydrogen to be used in equipment such as a fuel cell vehicle (hereinafter, also referred to as “FCV”).

The hydrogen station 12 includes a hydrogen production facility 14, a hydrogen storage facility 16, and a gateway device 18. The hydrogen production facility 14 includes a hydrogen generator (also referred to as water electrolysis apparatus or electrolysis tank) that produces hydrogen by electrolyzing water using electric power provided from a power grid. The hydrogen storage facility 16 includes a hydrogen tank that stores hydrogen produced by the hydrogen production facility 14. The gateway device 18 is a device that communicates with a device outside the hydrogen station 12 (in First Example, the device includes the management server 40 and a resource aggregation system 34 described later).

The management server 40 is an information processing apparatus that creates an operation plan for the hydrogen production facility 14. The management server 40 may create an operation plan for a plurality of hydrogen stations 12. The gateway device 18 of the hydrogen station 12 and the management server 40 are connected via a communication network 30 including a LAN, a WAN, and the Internet, and constitute an energy management system (EMS). In First Example, the creation of the operation plan for the hydrogen production facility 14 with the management server 40 is provided to the hydrogen station 12 as a cloud service. As a modification, the function of creating an operation plan for the hydrogen production facility 14 (the function of the management server 40 in First Example) may be implemented in a device installed in the hydrogen station 12.

The management server 40 is also connected to a power market price distribution device 32 via the communication network 30. The power market price distribution device 32 provides actual data or predicted data of the power price in the power market to an external device (the management server 40 or the like). The power price in First Example may vary for each unit time (30 minutes in First Example, and is hereinafter also referred to as a “frame”). The unit of the power price is, for example, yen/kWh (kilowatt-hour).

The gateway device 18 is also connected to the resource aggregation system 34 via the communication network 30. The resource aggregation system 34 is an information processing system of a business operator (resource aggregator) that integrally controls consumer-side energy resources and distributed energy resources.

The resource aggregation system 34 receives DR possible amount data including the baseline power and the power adjustable amount in DR from a consumer (in First Example, the gateway device 18 of the hydrogen station 12). The power adjustable amount in the DR includes one or both of “up DR possible amount” indicating the power adjustable amount in the up DR and “down DR possible amount” indicating the power adjustable amount in the down DR. In other words, the up DR possible amount is an amount that can increase power consumption. The down DR possible amount is an amount that can lower power consumption.

The resource aggregation system 34 transmits the DR command to the consumer (in First Example, the gateway device 18 of the hydrogen station 12) in response to the power demand adjustment request from a power company. The DR command includes “up DR command” that instructs up DR and “down DR command” that instructs down DR. That is, the resource aggregation system 34 issues an up DR command or a down DR command to the consumer in response to the power demand adjustment request from a power company.

FIG. 1 includes a block diagram illustrating functional blocks of gateway device 18. Each block illustrated in the block diagram of the present specification can be realized by a processor (CPU or the like) of a computer, an element including a memory, an electronic circuit, or a mechanical device in terms of hardware, and is realized by a computer program or the like in terms of software, but here, functional blocks realized by cooperation thereof are illustrated. Therefore, it is understood by the skilled person that these functional blocks can be realized in various forms by a combination of hardware and software.

The gateway device 18 includes a DR data transmission unit 20 and a DR command acquisition unit 22 as functional blocks related to DR. The DR data transmission unit 20 transmits the DR possible amount data to the resource aggregation system 34. The DR command acquisition unit 22 acquires the up DR command and the down DR command transmitted from the resource aggregation system 34. In the hydrogen station 12, the electrolytic power (also referred to as the hydrogen production amount) of the hydrogen production facility 14 is controlled based on the up DR command and the down DR command. Such processing related to DR in the resource aggregation system 34 and the hydrogen station 12 may be realized by a known technology.

FIG. 1 includes a block diagram illustrating functional blocks of the management server 40. The management server 40 includes a control unit 42, a storage unit 44, and a communication unit 46. The control unit 42 executes various data processing for creating an operation plan for the hydrogen production facility 14. The storage unit 44 includes one or both of a nonvolatile storage area and a volatile storage area, and stores data to be referred to or updated by the control unit 42. The communication unit 46 communicates with an external device in accordance with a predetermined communication protocol. The control unit 42 transmits and receives data to and from the gateway device 18 and the power market price distribution device 32 via the communication unit 46.

The storage unit 44 stores a plurality of constants used in the creation of the operation plan, in other words, a plurality of constants included in the objective function and the constraint condition used in the mathematical programming. The constant can be said to be a parameter whose value does not change in the optimization calculation of the objective function based on the mathematical programming. A value acquired from an external device, a past actual value, a design value, or an assumed value may be set to each constant.

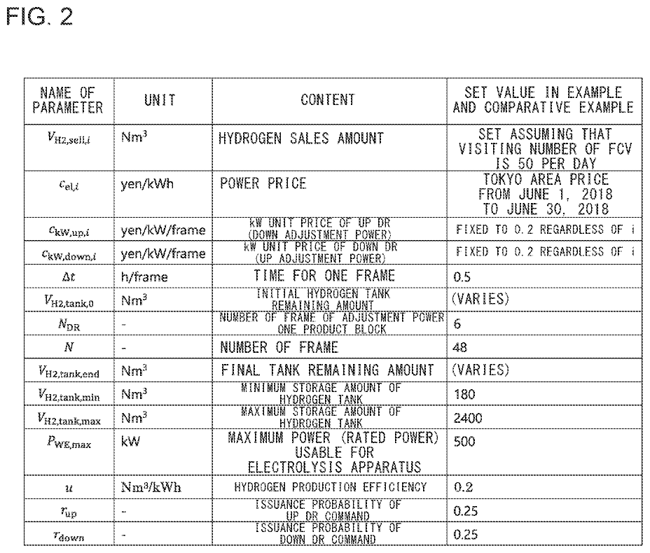

FIG. 2 illustrates a plurality of constants used in the creation of the operation plan. The index i of each constant represents a frame number. One frame is a unit time for creating the operation plan, and one frame in First Example is 30 minutes. In First Example, the target period for creating the operation plan is one day (0:00 to 24:00), and the operation plan is created based on the information obtained at the time of 9:00 of the previous day for each day of the target period. By repeating this processing based on the information for 30 days, an operation plan for 30 days is created. The initial value of the index i is 0, and the end value is 47 (2 frames/time×24 hours−1). Note that, the unit time for creating the operation plan may take any length, and the target period for creating the operation plan may also take any length. c_{kW,up,i} is a reward amount (that is, an up DR consideration) for increasing the power purchase amount in accordance with the up DR. c_{kW,down,i} is a reward amount (that is, a down DR consideration) for reducing the power purchase amount in accordance with the down DR. As N (number of frames), 48 (2 frames/hour x 24 hours), which is the number of frames per day, is set.

The storage unit 44 also stores a plurality of variables used in the creation of the operation plan, in other words, a plurality of variables included in the objective function and the constraint condition used in the mathematical programming. The variable can be said to be a parameter whose value is optimized by optimization calculation of an objective function based on the mathematical programming.

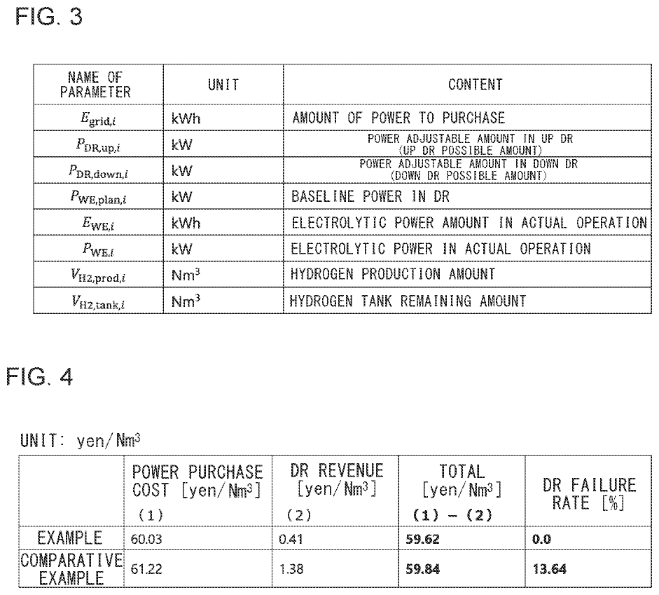

FIG. 3 illustrates the plurality of variables used in the creation of the operation plan. The index i of each variable is the same as the index i of the constant. The electrolytic power P_{WE,i} during actual operation of the hydrogen production facility 14 can also be said to be an operation amount of the hydrogen production facility 14 in each frame. The baseline power P_{WE,plan,i} in the DR is the electrolytic power of the hydrogen production facility 14 when the DR command does not come. The hydrogen remaining amount V_{H2,tank,i} is the remaining amount of hydrogen stored in the hydrogen storage facility 16.

The control unit 42 includes a parameter acquisition unit 48, a demand prediction unit 50, an operation plan creation unit 52, and an operation plan output unit 54. A computer program in which the functions of the plurality of functional blocks are implemented may be installed in a storage (the storage unit 44 or the like) of the management server 40. The control unit 42 may be realized by a processor (CPU or the like) of the management server 40. The processor of the management server 40 may perform the functions of the plurality of functional blocks by reading the computer program into the main memory and executing the computer program.

The parameter acquisition unit 48 acquires a value of a parameter (for example, a value of a constant parameter) used in the operation plan creation from an external device and stores the value in the storage unit 44. For example, the parameter acquisition unit 48 acquires data of the power price C_{el,i} (power price for each frame) used when creating the operation plan from the power market price distribution device 32. The parameter acquisition unit 48 may acquire the power price data of the same month of the previous year as the power price data of the period (hereinafter, it is also referred to as “planning target period”) in which the operation plan is created.

The demand prediction unit 50 predicts a hydrogen sales amount V_{H2,sell,i} (also referred to as hydrogen demand amount) for each frame in the planning target period and stores the data in the storage unit 44. The demand prediction unit 50 may predict the hydrogen sales amount in the planning target period based on the past hydrogen sales amount results, increase/decrease tendencies, weather information and traffic information regarding the planning target period, and the like.

The operation plan creation unit 52 creates an operation plan for the hydrogen production facility 14 using a mathematical programming. Expression 1 represents an objective function f in the operation plan creation.

$$f = {\sum }_{i} {c}_{el , i} {E}_{grid , i} - {\sum }_{i} {c}_{kW , up} {P}_{DR , up , i} - {\sum }_{i} {c}_{kW , down} {P}_{DR , down , i} \qquad ( Expression 1 )$$

The objective function f is to sum the difference between the power purchase cost and the earning from DR over all frames in the planning target period. The first term of the objective function f indicates the power purchase cost for each frame for operating the hydrogen production facility 14. In other words, the first term of the objective function f indicates the cost based on the amount of power related to the operation of the hydrogen production facility 14 for each frame, and in other words, indicates the cost based on the amount of energy consumed by the hydrogen production facility 14 for each frame.

The second term and the third term of the objective function f indicate the earning based on the DR possible amount for each frame of the amount of energy related to the operation of the hydrogen production facility 14 and the DR consideration for each frame. Specifically, the second term indicates the product of the up DR consideration in a certain frame and the up DR possible amount in the frame, that is, the earning obtained by responding to the up DR command in a certain frame. The third term indicates the product of the down DR consideration in a certain frame and the down DR possible amount in the frame, that is, the earning obtained by responding to the down DR command in a certain frame. In the objective function f of First Example, the earning is subtracted from the cost, and the smaller the value of the objective function f, the larger the revenue. Therefore, minimizing the value of the objective function f means maximizing the revenue.

The following Expression 2 to Expression 11 indicate constraint conditions in the operation plan creation.

$$\begin{matrix}{E}_{grid , i} = {E}_{WE , i} = {P}_{WE , i} Δ t & ( Expression 2 ) \\ {V}_{H 2 , prod , i} = u \cdot {E}_{WE , i} & ( Expression 3 ) \\ {V}_{H 2 , tank , i} = {V}_{H 2 , tank , 0} + {\sum }_{j = 0}^{i} ( {V}_{H 2 , prod , j} - {V}_{H 2 , sell , j} ) & ( Expression 4 ) \\ {V}_{H 2 , tank , N - 1} = {V}_{H 2 , tank , end} & ( Expression 5 ) \\ {V}_{H 2 , tank , min} \leq {V}_{H 2 , tank , i} \leq {V}_{H 2 , tank , max} & ( Expression 6 ) \\ 0 \leq {P}_{WE , i} \leq {P}_{WE , max} & ( Expression 7 ) \\ {P}_{WE , i} = {P}_{WE , plan , i} + {r}_{up} \times {P}_{DR , up , i} - {r}_{down} \times {P}_{DR , down , i} & ( Expression 8 ) \\ {P}_{DR , down , i} \leq {P}_{WE , plan , i} \leq {P}_{WE , max} - {P}_{DR , up , i} & ( Expression 9 ) \\ {P}_{DR , up , i} = {P}_{DR , up , i + 1} , i mod {N}_{DR} \neq {N}_{DR} - 1 & ( Expression 10 ) \\ {P}_{DR , down , i} = {P}_{DR , down , i + 1} , i mod {N}_{DR} \neq {N}_{DR} - 1 & ( Expression 11 )\end{matrix}$$

Expression 2 indicates a constraint in which the purchased power amount E_{grid,i} from the power grid per frame matches the power consumption amount E_{WE,i} of the hydrogen production facility 14. Expression 3 indicates a constraint on the relationship between a hydrogen production amount V_{H2,prod,i} and the power consumption amount E_{WE,i} of the hydrogen production facility 14. Expressions 4 to 6 indicates constraints on the hydrogen remaining amount in the hydrogen storage facility 16 (hydrogen tank). Expression 3, Expression 4, and Expression 6 define that a hydrogen remaining amount V_{H2,tank,i} in the hydrogen storage facility 16 determined according to the amount of power E_{WE,i} related to the operation of the hydrogen production facility 14 falls within a predetermined range (specifically, a minimum storage amount V_{H2,tank,min} or more and a maximum storage amount V_{H2,tank,max} or less) by combination.

Expression 4 and Expression 6 define that the hydrogen production amount satisfies the hydrogen sales amount. Expression 4 defines that the tank remaining amount is the sum of an increase due to past hydrogen production and a decrease due to hydrogen supply to the FCV. Expression 6 defines that the tank remaining amount is not below the minimum storage amount and not above the maximum storage mount. The minimum storage amount is, for example, the minimum amount of hydrogen to be stored in order to satisfy the hydrogen sales amount. The maximum storage amount is, for example, the capacity of the hydrogen tank. Alternatively, an amount provided with a margin may be set as the minimum storage amount or the maximum storage amount.

Expression 5 defines that the tank remaining amount (final tank remaining amount) when one operation plan ends (that is, when the index i of the frame number reaches the final value) is set as a specified value. When Expression 5 is not provided, an operation plan is created such that the final tank remaining amount becomes zero when the objective function is optimized. However, when the tank remaining amount becomes zero, hydrogen cannot be supplied to the FCV. Providing Expression 5 makes it possible to create an optimal operation plan while leaving only the specified amount of the final tank remaining amount. In First Example, the final tank remaining amount is half the maximum storage amount of the hydrogen tank.

Expression 7 is a constraint on the electrolytic power P_{WE,i} (in other words, power consumption) of the hydrogen production facility 14. Expression 8 represents a constraint on the electrolytic power P_{WE,i} assuming that an up DR command is received with a first probability (rᵤₚ) and a down DR command is received with a second probability (r_{down}). The first probability (rᵤₚ) is an expected value and an assumed value for receiving the up DR command, and is 0.25 in First Example. The second probability (r_{down}) is an expected value and an assumed value for receiving the down DR command, and is 0.25 in First Example. These values can be appropriately set based on experiments or simulations. Including Expression 8 in the constraint conditions makes it possible to more accurately calculate the hydrogen production amount including the response to DR, and thus, a plan with higher feasibility can be created.

Expression 9 indicates a constraint that defines that the DR possible amount falls within a controllable range in terms of the operation of the hydrogen production facility 14. Specifically, Expression 9 defines that the baseline power P_{WE,plan,i} in the DR is set to be equal to or more than the down DR possible amount P_{DR,down,i}, that is, a value that can respond to the down DR command. Expression 9 further defines that the baseline power P_{WE,plan,i} in the DR is set to be equal to or less than the difference between the rated power of the hydrogen production facility 14 and the up DR possible amount P_{DR,up,i}, that is, a value that can respond to the up DR command. Including Expression 9 in the constraint conditions makes it possible to enhance responsiveness to the DR command.

Expression 10 and Expression 11 are constraints for calculating the DR possible amount according to the length (for example, 3 hours) of the product block in the power supply and demand adjustment market. “mod” in Expression 10 and Expression 11 represents a remainder operation. The length of the product block in the power supply and demand adjustment market is a period during which the power demand (power purchase amount) should be adjusted according to one DR command, and is determined by market requirements.

The operation plan creation unit 52 derives the DR possible amount (the up DR possible amount and the down DR possible amount) for each frame for optimizing the objective function f shown in Expression 1 using a mathematical programming (for example, mixed integer linear programming). At the same time, the operation plan creation unit 52 further derives the amount of power related to the operation of the hydrogen production facility 14 for each frame for optimizing the objective function f.

Specifically, the operation plan creation unit 52 derives a value of an explanatory variable that minimizes (that is, maximizes revenue) the objective function f under the constraint conditions indicated in Expressions 2 to 7 based on the parameter values stored in the storage unit 44. This explanatory variable includes, for example, E_{grid,i}, P_{DR,up,i}, P_{DR,down,i}, P_{WE,plan,i}, E_{WE,i}, P_{WE,i}, V_{H2,prod,i}, and V_{H2,tank,i}. A known technique may be used for solving the explanatory variable by the mathematical programming.

The operation plan creation unit 52 creates data of the operation plan for the hydrogen production facility 14 based on each derived variable value. For example, the operation plan creation unit 52 may create operation plan data including values of the purchased power amount E_{grid,i}, the up DR possible amount P_{DR,up,i}, the down DR possible amount P_{DR,down,i}, the baseline power P_{WE,plan,i} in DR, and the electrolytic power (in other words, the operation amount) P_{WE,i} of the hydrogen production facility 14 of the hydrogen production facility 14 for each frame in the planning target period.

The operation plan output unit 54 transmits data of the operation plan created by the operation plan creation unit 52 to the hydrogen station 12 (gateway device 18).

An operation of the hydrogen production system 10 having the above configuration will be described. The parameter acquisition unit 48 of the management server 40 acquires values of various parameters necessary for creating an operation plan for the hydrogen production facility 14 from an external device and stores the values in the storage unit 44. The demand prediction unit 50 of the management server 40 predicts the hydrogen sales amount in the planning target period and stores the prediction value in the storage unit 44. The operation plan creation unit 52 of the management server 40 inputs the values of the plurality of parameters stored in the storage unit 44 to the objective function of Expression 1 and the constraint conditions of Expressions 2 to 11, and derives an explanatory variable (power purchase amount E_{grid,i} or the like) that minimizes the objective function using the mathematical programming. The operation plan creation unit 52 creates an operation plan data based on each variable value derived using the mathematical programming. For example, the management server 40 (information processing apparatus) includes a processor, and the processor performs creation of an operation plan for the hydrogen production facility including the demand response possible amount for each unit time based on the demand response consideration for each unit time (first step).

The operation plan output unit 54 of the management server 40 transmits the operation plan data to the gateway device 18 of the hydrogen station 12. For example, the processor of the management server 40 outputs data including the operation plan created in the first step (second step). In the hydrogen station 12, the power purchase from the power grid and the operation of the hydrogen production facility 14 are controlled according to the operation plan data transmitted from the management server 40, and hydrogen is produced.

In addition, the gateway device 18 of the hydrogen station 12 transmits the DR possible amount data including the up DR possible amount, the down DR possible amount, and the baseline power in the DR indicated by the operation plan data to the resource aggregation system 34. The gateway device 18 receives the up DR command or the down DR command transmitted from the resource aggregation system 34. In the hydrogen station 12, when the hydrogen remaining amount in the hydrogen storage facility 16 can be maintained within a range of the minimum storage amount or more and the maximum storage amount or less, the power consumption is adjusted. For example, according to the up DR command, the electrolytic power of the hydrogen production facility 14 is increased to increase the hydrogen production amount. Alternatively, according to the down DR command, the electrolytic power of the hydrogen production facility 14 is lowered to reduce the hydrogen production amount. Alternatively, the operation of the hydrogen production facility 14 is stopped according to the down DR command.

According to the hydrogen production system 10 (the management server 40) of First Example, it is possible to set an appropriate DR possible amount according to the hydrogen remaining amount in the hydrogen storage facility 16 and the DR consideration for each unit time. Setting an appropriate DR possible amount makes it possible to suppress the occurrence of a situation in which the DR command cannot be followed. In principle, the DR command should be followed. When the DR command is not followed, a penalty may be imposed, and the earning obtained by responding to the DR command may be reduced. According to the hydrogen production system 10 (the management server 40) of First Example, it is possible to avoid generation of a penalty and to avoid a decrease in the earning obtained by responding to the DR command. That is, according to the hydrogen production system 10 (the management server 40) of First Example, it is possible to create an efficient operation plan for the hydrogen production facility 14 in consideration of the value of performing DR. Penalties for not following the DR command include imposition of a fine and loss of participation in the power supply and demand adjustment market. Therefore, it is important to suppress the occurrence of a situation in which the DR command cannot be followed.

Hereinafter, the results of a control simulation by the operation plan creation method of First Example and the operation plan creation method of Comparative Example will be described. In this simulation, an actual contract price in a power wholesale market in Japan (Tokyo area price from Jun. 1, 2018 to Jun. 30, 2018) was used as the power price C_{el,i}. A demand curve was created assuming that the number of FCVs visiting the hydrogen station 12 was 50 per day, and a hydrogen sales amount V_{H2,sell,i} for each frame was set.

Expression 12 represents an objective function of Comparative Example.

$$f = {\sum }_{i} ( {c}_{el , i} {E}_{grid , i} ) \qquad ( Expression 12 )$$

The objective function of Comparative Example includes only the first term of the objective function of First Example. That is, the objective function of Comparative Example is obtained by excluding the second term indicating the earning obtained by responding to the up DR command and the third term indicating the earning obtained by responding to the down DR command from the objective function of First Example.

Other conditions (constraint conditions, seed value of random number, and the like) other than the objective function were the same between First Example and Comparative Example, and the control simulation for 30 days was performed in each of First Example and Comparative Example. That is, in each of First Example and Comparative Example, an operation plan for 30 days for the hydrogen production facility 14 was created by repeatedly performing an operation plan for one day based on 30 days of information. Hereinafter, increasing the power purchase amount (in other words, the electrolytic power of the hydrogen production facility 14) in response to the up DR command and decreasing the power purchase amount in response to the down DR command are also referred to as “DR success”. Not increasing the power purchase amount despite receiving the up DR command and not decreasing the power purchase amount despite receiving the down DR command are also referred to as “DR failure”.

Specifically, in First Example, an operation plan is created on each day of 30 days, and the electrolytic power (P_{WE,i}), the DR baseline (P_{WE,plan,i}), and the DR possible amount (P_{DR,up,i} and P_{DR,down,i}) of the hydrogen production facility 14 for the next day are calculated. In First Example, the DR baseline (P_{WE,plan,i}) for the next day calculated in each day and the DR possible amount (P_{DR,up,i} and P_{DR,down,i}) are submitted to the resource aggregator. On the other hand, in Comparative Example, an operation plan is created on each day of 30 days, and the power (so-called available capacity) of the hydrogen production amount exceeding the hydrogen sales amount on each day is submitted to the resource aggregator as the DR possible amount.

In each of First Example and Comparative Example, in each frame of the next day, the DR command (the up DR command or the down DR command) was randomly given based on the random number within the range of the DR possible amount submitted to the resource aggregator on the previous day. However, the up DR command and the down DR command were not issued at the same time. When an up DR command is issued such that the hydrogen remaining amount (V_{H2,tank,i}) in the hydrogen storage facility 16 exceeds the upper limit (V_{H2,tank,max}), the up DR command is ignored and the hydrogen production is stopped, resulting in DR failure. When a down DR command is issued such that the hydrogen remaining amount (V_{H2,tank,i}) in the hydrogen storage facility 16 falls below the lower limit (V_{H2,tank,min}), the down DR command is ignored and hydrogen production is performed, resulting in DR failure.

FIG. 4 illustrates results (estimation results) of the control simulation of First Example and Comparative Example. In this estimation, the power purchase cost per unit hydrogen production amount (1 Nm³) when the hydrogen production facility 14 was operated according to the operation plan was obtained in each of First Example and Comparative Example. The power purchase cost is a value obtained by dividing the sum of the first term of the objective function for 30 days by the sum of the hydrogen production amounts V_{H2,prod,i} for 30 days.

In this estimation, DR revenue per unit hydrogen production amount (1 Nm³) was obtained in each of First Example and Comparative Example. This DR revenue is a value obtained by dividing the sum of the DR consideration for 30 days at the time of DR success by the sum of the hydrogen production amounts V_{H2,prod,i} for 30 days. Further, the DR failure rate was obtained in each of First Example and Comparative Example. This DR failure rate is a value obtained by dividing the number of DR failures for 30 days by the number of DR commands for 30 days.

As shown in FIG. 4, in First Example as compared with Comparative Example, the DR possible amount of each frame was calculated in consideration of the power price of each frame, and thus the power purchase cost was reduced and the overall revenue (value in “Total” field, revenue is larger as value is smaller) was improved. In addition, in First Example, the DR failure rate was reduced because the DR possible amount in consideration of the hydrogen remaining amount in the hydrogen production facility 14 was calculated.

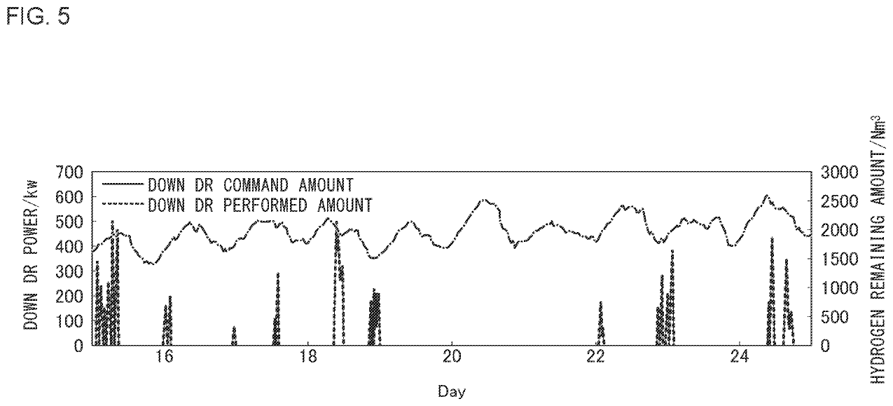

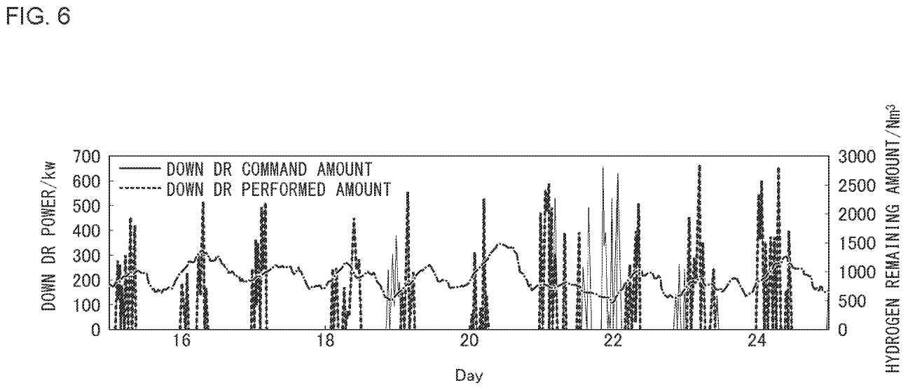

FIG. 5 illustrates the results of the control simulation of First Example, and FIG. 6 illustrates the results of the control simulation of Comparative Example. The horizontal axis in both drawings indicates the date and time of the simulation period. The vertical axis on the right side indicates the hydrogen remaining amount (unit: Nm³) in the hydrogen storage facility 16. The vertical axis on the left side indicates power (unit: kW) related to the down DR. The dashed-dotted line in each of the drawings shows a change in the hydrogen remaining amount in the hydrogen storage facility 16. The solid line indicates the DR command amount (power to be reduced). The broken line indicates the performed amount of down DR (actually reduced power) in the hydrogen station 12.

As shown in FIG. 5, according to the operation plan creation method of First Example, the hydrogen remaining amount in the hydrogen storage facility 16 stably changed. Then, all the down DR commands were followed. In the power supply and demand adjustment market, it is necessary to succeed in DR in principle, but according to the operation plan creation method of First Example, it is possible to satisfy the requirements of the power supply and demand adjustment market while satisfying the hydrogen demand.

On the other hand, a down DR command is issued on 19th and 22nd in FIG. 6, but the down DR command is not executed in the hydrogen station 12, resulting in DR failure. In Comparative Example, it is not possible to calculate the DR possible amount according to the amount of hydrogen demand, and thus the hydrogen stock may be equal to or lower than the lower limit when receiving the down DR command. In this case, the hydrogen production (the operation of the hydrogen production facility 14) has to be performed ignoring the down DR command, resulting in DR failure. In Comparative Example, the hydrogen stock at the time of receiving an up DR command may be equal to or higher than the upper limit. In this case, the hydrogen production (the operation of the hydrogen production facility 14) has to be stopped ignoring the up DR command, which also results in DR failure.

The present disclosure has been described above based on First Example. It is to be understood by the skilled person that First Example is an example, various modifications can be made to the combination of each component or each processing process, and such modifications are also within the scope of the present disclosure.

For example, in First Example, the objective function f is formed only of the first term representing the power cost and the second and third terms representing the degradation loss of the facility, but other configurations may be used. For example, when the power cost is always constant, an objective function not including the first term may be used. For example, when the hydrogen sales price varies depending on the time zone, the sum of the product of the hydrogen sales price and the hydrogen production amount for each time may be included in the objective function. In addition, the constraint conditions used in First Example are not necessarily used, and constraint conditions other than the constraint conditions used in First Example may be used. For example, when hydrogen is not produced outside business hours, a constraint condition that the hydrogen production amount outside business hours is 0 may be included.

In addition, for example, in First Example, the hydrogen production facility 14 is provided in the hydrogen station 12, but as a modification, the hydrogen production facility 14 may be provided in a hydrogen supply facility for a fuel cell, chemical synthesis, or the like. The hydrogen production facility 14 may be provided in an energy (electric power, heat, hydrogen, and the like) supply system, and the energy supply system may include a storage battery, a fuel cell, and the like together with the hydrogen production facility 14.

In First Example, the operation plan output unit 54 of the management server 40 transmits the operation plan data to the hydrogen production system 10 (gateway device 18). As a modification, the operation plan output unit 54 may store the operation plan data in a predetermined local or remote storage area. The operation plan output unit 54 may output the operation plan data to a predetermined display device and cause the display device to display the driving plan.

In First Example, the gateway device 18 of the hydrogen station 12 includes the DR data transmission unit 20 and the DR command acquisition unit 22 that transmit and receive data to and from the resource aggregation system 34. As a modification, the management server 40 may include the DR data transmission unit 20 or the DR command acquisition unit 22. For example, the management server 40 may further include a DR command transfer unit in addition to the DR data transmission unit 20 and the DR command acquisition unit 22. When the DR command acquisition unit 22 acquires the DR command transmitted from the resource aggregation system 34, the DR command transfer unit may transfer data of the DR command to the gateway device 18 of the hydrogen station 12. Alternatively, the management server 40 may include the DR data transmission unit 20, and the gateway device 18 of the hydrogen station 12 may include the DR command acquisition unit 22. In other words, the management server 40 may directly transmit the DR possible amount (P_{DR,up,i} and P_{DR,down,i}) calculated by the control unit 42 (operation plan creation unit 52) to the resource aggregation system 34 via the communication unit 46, and the hydrogen station 12 (the DR command acquisition unit 22 of the gateway device 18) may directly receive the DR command from the resource aggregation system 34.

In First Example, the planning target period is one day. However, the planning target period is not limited to this period. When longer-term demand prediction or price prediction information is available, the planning target period may be longer than one day. The planning target period in this case may be, for example, 7 days (2 frames/hour×24 hours×7 days=336 frames). In addition, a shorter operation plan may be created at a higher frequency. For example, a plan for six hours in the future may be created every three hours.

The parameter acquisition unit 48 of the management server 40 may acquire values of parameters for creating the operation plans for a plurality of hydrogen production facilities 14 from an external device. The storage unit 44 of the management server 40 may store the values of the parameters for creating operation plans for the plurality of hydrogen production facilities 14. The plurality of hydrogen production facilities 14 may be intensively installed in one hydrogen station 12 or may be dispersedly installed in a plurality of hydrogen stations 12. The operation plan creation unit 52 of the management server 40 may create the operation plan for each of the plurality of hydrogen production facilities including the DR possible amount for each unit time based on the parameters of each hydrogen production facility 14 including the DR consideration for each unit time. The operation plan output unit 54 of the management server 40 may transmit data including the operation plan for each of the plurality of hydrogen production facilities 14 to the gateway device 18 of the hydrogen station 12 in which each hydrogen production facility 14 is installed.

Although not mentioned in First Example, in the hydrogen station 12, a device (here, it is referred to as “instruction device”) that instructs the hydrogen production facility 14 to produce hydrogen based on the data including the operation plan transmitted from the hydrogen production facility 14 may be installed. For example, the instruction device may control the operation of the hydrogen production facility 14 according to the electrolytic power P_{WE,i} of the hydrogen production facility 14 of each frame indicated by the operation plan. The gateway device 18 of the hydrogen station 12 may include a function of the instruction device. In addition, the hydrogen production facility 14 may produce hydrogen based on instruction data from the instruction device, and may vary the hydrogen production amount for each frame.

### Second Example

Second Example of the present disclosure will be described focusing on differences from First Example, and description of common points will be appropriately omitted. It goes without saying that the features of Second Example can be freely combined with the features of First Examples and modifications. Among the components of Second Example, components that are the same as or correspond to the components of First Example will be appropriately denoted by the same reference numerals and described.

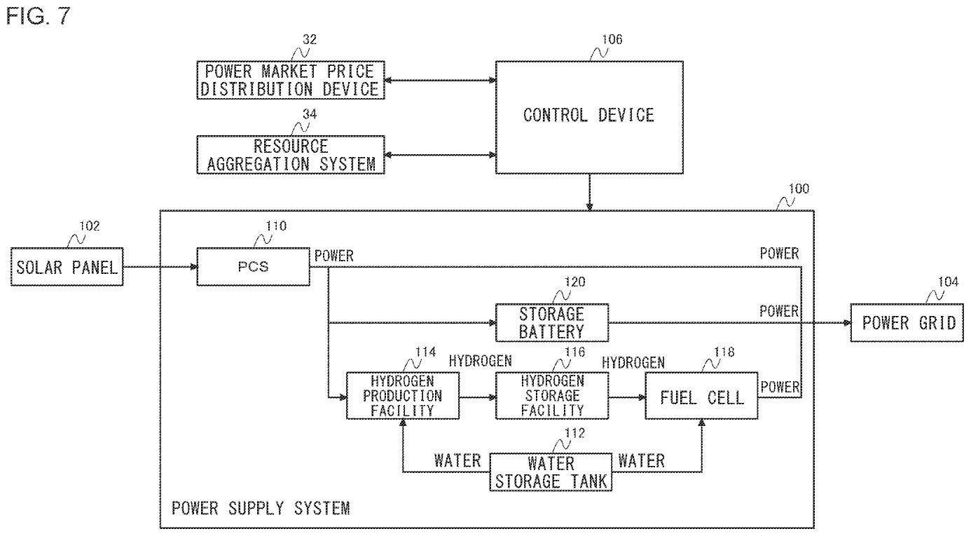

In Second Example, the technical idea described in First Example is applied to a power supply system including a hydrogen production facility. FIG. 7 is a diagram illustrating a configuration of a power supply system 100 of Second Example. The power supply system 100 is a self-sustaining power supply system that supplies power to a power grid 104 using power from a renewable energy power generator that generates power using renewable energy, for example, a solar power generator (solar panel 102) that generates power using sunlight. The power grid 104 is a system owned by a general power transmission and distribution company, and is a system that integrates power generation, transformation, power transmission, and power distribution for supplying power to a power receiving facility of a consumer.

The power supply system 100 includes a power conditioner device 110 (hereinafter, referred to as “PCS 110”), a water storage tank 112, a hydrogen production facility 114, a hydrogen storage facility 116, a fuel cell 118, a storage battery 120, and a control device 106. In the example of FIG. 7, the control device 106 is disposed outside the power supply system 100, but the present disclosure is not limited to this example. The control device 106 may be configured as a part of the power supply system 100.

The solar panel 102 includes a solar cell and constitutes a solar power generator that generates electric power by receiving sunlight at the solar cell and performing photoelectric conversion. Although the solar panel 102 is illustrated in FIG. 7, another power generator may be adopted as long as the power generator generates electric power using renewable energy. For example, a wind power generator that generates electric power from wind power may be adopted. A hydraulic power generator that generates electric power from hydraulic power may also be adopted. A geothermal power generator, a wave power generator, a temperature difference power generator, or a biomass power generator may be adopted. Further, a combination of power generators that generate electric power using these renewable energies may be adopted.

The PCS 110 adjusts the power generated by the solar panel 102. Here, the PCS 110 converts the power from the solar panel 102 into power that can be supplied to the power grid 104.

The water storage tank 112 stores water and supplies the stored water to the hydrogen production facility 114 and the fuel cell 118. In the example of FIG. 7, the water storage tank 112 is disposed inside the power supply system 100, but the present disclosure is not limited to this example. The water storage tank 112 may be provided outside the power supply system 100. As a modification, the power supply system 100 may supply water directly from the outside (for example, a water pipe) to the hydrogen production facility 114 and the fuel cell 118.

The hydrogen production facility 114 corresponds to the hydrogen production facility 14 of First Example. The hydrogen production facility 114 produces hydrogen by using at least a part of surplus power that is not supplied to the power grid 104 among the power adjusted by the PCS 110. Specifically, under the control of the control device 106, the hydrogen production facility 114 produces hydrogen by electrolyzing water supplied from the water storage tank 112 using electric power generated by the solar panel 102 and then adjusted by the PCS 110. In addition, the hydrogen production facility 114 includes a measuring instrument (not illustrated) such as a gas sensor, a pressure gauge, or a flow meter, and data measured by the measuring instrument is output to the control device 106 as a data signal.

The hydrogen storage facility 116 corresponds to the hydrogen storage facility 16 of First Example. As the hydrogen storage facility 116, a known facility capable of storing and releasing hydrogen can be adopted. For example, the hydrogen storage facility 116 includes a hydrogen absorbing alloy excellent in absorbing and releasing hydrogen, and stores and releases hydrogen produced by the hydrogen production facility 114 under the control of the control device 106. In addition, the hydrogen storage facility 116 includes a measuring instrument (not illustrated) such as a gas sensor, a pressure gauge, or a flow meter, and data measured by the measuring instrument is output to the control device 106 as a data signal.

Under the control of the control device 106, the fuel cell 118 generates power using hydrogen discharged from the hydrogen storage facility 116 and generates hot water using water supplied from the water storage tank 112 and exhaust heat. The power generated through the power generation of the fuel cell 118 is supplied to the power grid 104. The fuel cell 118 includes a measuring instrument (not illustrated) such as a gas sensor, a pressure gauge, or a flow meter, and a measuring instrument (not illustrated) that measures a reserved amount of hydrogen, and data measured by the measuring instrument is output to the control device 106 as a data signal.

The storage battery 120 stores at least a part of surplus power not supplied to the power grid 104 in the power adjusted by the PCS 110 and discharges the stored power. Specifically, the storage battery 120 stores the power generated by the solar panel 102 and adjusted by the PCS 110 under the control of the control device 106. The power stored in the storage battery 120 can be supplied to the power grid 104 by being discharged under the control of the control device 106. The storage battery 120 includes a measuring instrument (not illustrated) that measures the storage amount, and data measured by the measuring instrument is output to the control device 106 as a data signal.

The control device 106 is realized as, for example, an energy management system (EMS), and is configured as control means that controls each unit constituting the power supply system 100. The control device 106 includes an arithmetic unit (not illustrated) and a memory (not illustrated), and controls each unit by the arithmetic unit performing arithmetic processing using a program stored in the memory device. For example, the control device 106 performs control on the production amount of hydrogen in the hydrogen production facility 114, the storage amount/release amount of hydrogen in the hydrogen storage facility 116, the power generation amount in the fuel cell 118, the storage amount/discharge amount in the storage battery 120, and the like as control targets based on various types of information obtained from the outside or the inside of the power supply system 100.

The control device 106 is connected to the power market price distribution device 32 and the resource aggregation system 34 via a communication network. The control device 106 has the function of the management server 40 of First Example and the function of the gateway device 18 of First Example. For example, like the management server 40 of First Example, the control device 106 may include the parameter acquisition unit 48, the demand prediction unit 50, the operation plan creation unit 52, and the operation plan output unit 54 (not illustrated). The control device 106 may include the DR data transmission unit 20 and the DR command acquisition unit 22 (not illustrated) like the gateway device 18 of First Example.

The control device 106 creates an operation plan for the hydrogen production facility 114 including the demand response possible amount for each unit time based on the demand response consideration for each unit time, like the management server 40 of First Example. In the creation of the operation plan, the configuration described in First Example can be applied. The control device 106 controls the hydrogen production facility 114 based on the created operation plan, like the gateway device 18 of First Example.

According to the power supply system 100 of Second Example, it is possible to create an efficient operation plan for the hydrogen production facility 114 in consideration of the value of performing DR, and it is possible to improve the overall economic efficiency related to the operation of the hydrogen production facility 114 in the power supply system 100.

The present disclosure has been described above based on Second Example. It is to be understood by the skilled person that Second Example is an example, various modifications can be made to the combination of each component or each processing process, and such modifications are also within the scope of the present disclosure.

Any combination of the above-described examples and modifications is also useful as an embodiment of the present disclosure. A new embodiment generated by the combination has the effect of each of the combined examples and modifications. In addition, it is understood by the skilled person that the functions to be performed by the components described in the claims are realized by a single body of each component described in examples and the modifications or by cooperation of the components.

The technology described in the present disclosure can also be expressed as the following items.

### [Item 1]

An information processing apparatus (40) including a processor (42), wherein
the processor (42) executes:
a first step of creating an operation plan for a hydrogen production facility (14) including a demand response possible amount for each unit time based on a demand response consideration for the each unit time; and
a second step of outputting data including the operation plan created in the first step.

According to this information processing apparatus, it is possible to create an operation plan for a hydrogen production facility in which revenue from demand response is quantitatively taken into consideration, and it is possible to improve the overall economic efficiency related to the operation of the hydrogen production facility.

### [Item 2]

The information processing apparatus (40) according to item 1, wherein
the first step executes processing using a mathematical programming on an objective function to derive the demand response possible amount for the each unit time, and
the objective function includes a term indicating an earning based on the demand response possible amount for the each unit time of an amount of power related to an operation of the hydrogen production facility (14) and the demand response consideration for the each unit time.

According to this information processing apparatus, it is possible to create a more efficient operation plan in which revenue from demand response is quantitatively taken into consideration using a mathematical programming.

### [Item 3]

The information processing apparatus (40) according to item 2, wherein
the objective function further includes a term indicating a cost based on the amount of power related to the operation of the hydrogen production facility (14) for the each unit time, and
the first step further derives the amount of power related to the operation of the hydrogen production facility (14) for the each unit time.

According to this information processing apparatus, it is possible to obtain an optimum value for each unit time for the amount of power related to the operation of the hydrogen production facility and create a more useful operation plan.

### [Item 4]

The information processing apparatus (40) according to item 2 or 3, wherein
a constraint condition on the objective function includes a constraint condition defining that the demand response possible amount falls within a controllable range in operation of the hydrogen production facility (14).

According to this information processing apparatus, it is possible to suppress occurrence of a situation in which a demand response command cannot be followed (failure of demand response).

### [Item 5]

The information processing apparatus (40) according to any one of items 2 to 4, wherein
a constraint condition on the objective function includes a constraint condition defining that a hydrogen remaining amount in a hydrogen storage facility (16) determined according to the amount of power related to the operation of the hydrogen production facility (14) falls within a predetermined range.

According to this information processing apparatus, it is possible to suppress occurrence of a situation in which a demand response command cannot be followed (failure of demand response) because of a hydrogen remaining amount in the hydrogen storage facility.

### [Item 6]

A hydrogen production system (10) including:
a hydrogen production facility (14); and
an information processing apparatus (40), wherein
the information processing apparatus (40) executes:
a first step of creating an operation plan for the hydrogen production facility (14) including a demand response possible amount for each unit time based on a demand response consideration for the each unit time; and
a second step of outputting data including the operation plan created in the first step.

According to this hydrogen production system, it is possible to create an operation plan for a hydrogen production facility in which revenue from demand response is quantitatively taken into consideration, and it is possible to improve the overall economic efficiency related to the operation of the hydrogen production facility.

### [Item 7]

A power supply system that supplies power to a power grid using power obtained from a renewable energy power generator that generates power using renewable energy, the power supply system including:
a power conditioner device that adjusts power generated by the renewable energy power generator;
a storage battery capable of storing and discharging at least a part of surplus power that is not supplied to the power grid among power adjusted by the power conditioner device;
a hydrogen production facility that produces hydrogen by using at least a part of the surplus power that is not supplied to the power grid among the power adjusted by the power conditioner device;
a hydrogen storage facility capable of storing and releasing hydrogen produced by the hydrogen production facility;
a fuel cell that generates power using hydrogen released from the hydrogen storage facility; and
control means that controls at least an operation of the hydrogen production facility, wherein
the control means creates an operation plan for the hydrogen production facility including a demand response possible amount for each unit time based on a demand response consideration for the each unit time, and controls the hydrogen production facility based on the operation plan.

According to this power supply system, it is possible to create an operation plan for a hydrogen production facility in which revenue from demand response is quantitatively taken into consideration, and it is possible to improve the overall economic efficiency related to the operation of the hydrogen production facility.

### [Item 8]

An operation plan creation method, wherein
a computer (40) executes:
a first step of creating an operation plan for a hydrogen production facility (14) including a demand response possible amount for each unit time based on a demand response consideration for the each unit time; and
a second step of outputting data including the operation plan created in the first step.

According to this operation plan creation method, it is possible to create an operation plan for a hydrogen production facility in which revenue from demand response is quantitatively taken into consideration, and it is possible to improve the overall economic efficiency related to the operation of the hydrogen production facility.

### [Item 9]

A computer program that causes a computer (40) to execute:
a first step of creating an operation plan for a hydrogen production facility (14) including a demand response possible amount for each unit time based on a demand response consideration for the each unit time; and
a second step of outputting data including the operation plan created in the first step.

According to this computer program, it is possible to cause a computer to create an operation plan for a hydrogen production facility in which revenue from demand response is quantitatively taken into consideration, and it is possible to improve the overall economic efficiency related to the operation of the hydrogen production facility.

### INDUSTRIAL APPLICABILITY

The technology of the present disclosure can be applied to an apparatus or a system that creates an operation plan for a hydrogen production facility.

### REFERENCE SIGNS LIST

10 hydrogen production system, 14 hydrogen production facility, 40 management server, 44 storage unit, 48 parameter acquisition unit, 50 demand prediction unit, 52 operation plan creation unit, 54 operation plan output unit, 100 power supply system, 102 solar panel, 104 power grid, 106 control device, 110 PCS, 114 hydrogen production facility, 116 hydrogen storage facility, 118 fuel cell, 120 storage battery.

1. An information processing apparatus comprising a processor, wherein the processor executes:
a first step of creating an operation plan for a hydrogen production facility including a demand response possible amount for each unit time based on a demand response consideration for the each unit time; and
a second step of outputting data including the operation plan created in the first step.

2. The information processing apparatus according to claim 1, wherein
the first step executes processing using a mathematical programming on an objective function to derive the demand response possible amount for the each unit time, and
the objective function includes a term indicating an earning based on the demand response possible amount for the each unit time of an amount of power related to an operation of the hydrogen production facility and the demand response consideration for the each unit time.

3. The information processing apparatus according to claim 2, wherein
the objective function further includes a term indicating a cost based on the amount of power related to the operation of the hydrogen production facility for the each unit time, and
the first step further derives the amount of power related to the operation of the hydrogen production facility for the each unit time.

4. The information processing apparatus according to claim 2, wherein
a constraint condition on the objective function includes a constraint condition defining that the demand response possible amount falls within a controllable range in operation of the hydrogen production facility.

5. The information processing apparatus according to claim 2, wherein
a constraint condition on the objective function includes a constraint condition defining that a hydrogen remaining amount in a hydrogen storage facility determined according to the amount of power related to the operation of the hydrogen production facility falls within a predetermined range.

6. A hydrogen production system comprising:
a hydrogen production facility; and
an information processing apparatus, wherein
the information processing apparatus executes:
a first step of creating an operation plan for the hydrogen production facility including a demand response possible amount for each unit time based on a demand response consideration for the each unit time; and
a second step of outputting data including the operation plan created in the first step.

7. A power supply system that supplies power to a power grid using power obtained from a renewable energy power generator that generates power using renewable energy, the power supply system comprising:
a power conditioner device structured to adjust power generated by the renewable energy power generator;
a storage battery capable of storing and discharging at least a part of surplus power that is not supplied to the power grid among power adjusted by the power conditioner device;
a hydrogen production facility structured to produce hydrogen by using at least a part of the surplus power that is not supplied to the power grid among the power adjusted by the power conditioner device;
a hydrogen storage facility capable of storing and releasing hydrogen produced by the hydrogen production facility;
a fuel cell structured to generate power using hydrogen released from the hydrogen storage facility; and
control means structured to control at least an operation of the hydrogen production facility, wherein
the control means creates an operation plan for the hydrogen production facility including a demand response possible amount for each unit time based on a demand response consideration for the each unit time, and controls the hydrogen production facility based on the operation plan.

8. An operation plan creation method, wherein
a computer executes:
a first step of creating an operation plan for a hydrogen production facility including a demand response possible amount for each unit time based on a demand response consideration for the each unit time; and
a second step of outputting data including the operation plan created in the first step.

9. A non-transitory computer-readable storage medium storing a computer program that causes a computer to execute:
a first step of creating an operation plan for a hydrogen production facility including a demand response possible amount for each unit time based on a demand response consideration for the each unit time; and
a second step of outputting data including the operation plan created in the first step.
